(19) United States
(12) Patent Application Publication
(10) Pub. No.: US 2007/0115572 A1
(43) Pub. Date: May 24, 2007

(54) Device and method of making a device having a meandering layer on a flexible substrate

(75) Inventors: Dirkjan B. Van Dam, Eindhoven (NL); Petrus C.P. Bouten, Eindhoven (NL); Gerwin H. Gelinck, Valkenswaard (NL); Hjalmar E.A. Huitema, Veldhoven (NL); Bas J.E. Van Rens, Son (NL)

Correspondence Address: PHILIPS INTELLECTUAL PROPERTY & STANDARDS, P.O. BOX 3001, BRIARCLIFF MANOR, NY, 10510, US

(73) Assignee: KONINKLJKE PHILIPS ELECTRONICS N.V., Eindhoven (NL)

(21) Appl. No.: 10/574,144

(22) PCT Filed: Sep. 30, 2004
(86) PCT No.: PCT/IB04/51930

§ 371 Date: Mar. 29, 2006

(30) Foreign Application Priority Data
Oct. 4, 2003 (GB) 0323285.7

(51) Int. Cl. G02B 5/08

(52) U.S. Cl. 359/883

(57) ABSTRACT

A device such as a flexible LCD is described comprising first and second layers wherein the first layer is a flexible substrate and the second layer is a brittle ITO conduction line applied to the substrate. The ITO layer is substantially flat and meanders across the plane of the flexible substrate so as to prevent fracture of the ITO layer when the flexible substrate is deformed. The ITO layer may be subdivided into portions, the length of the portions being selected to prevent fracture when the flexible substrate is deformed to a predetermined radius of curvature.

This application relates to the field of flexible devices, particularly but not exclusively to flexible electronic devices including flexible electronic displays. More particularly, this application relates to the topographical shape of a layer on a flexible substrate, wherein the topographical shape of the layer enables it to withstand higher levels of strain before fracture than conventional layers.

Flexible substrates are substrates that may be deformed whilst maintaining their functional integrity. They can, for example, be made of plastic, metal foil or very thin glass; in general they will have a low elastic modulus or be relatively thin. The development of flexible substrates allows greater freedom in the design of electronic devices and thus enables the development of previously impracticable electronic appliances in numerous areas of technology. One example is the development of flexible electronic displays. These have numerous benefits over the rigid devices that are currently available. Curved or roll-up displays could be developed which are cheap enough to manufacture and have sufficient flexibility and durability such that they could, one day, supersede paper.

A limitation to the production of flexible displays is that the flexible substrates often require coatings of more brittle materials. An example of one of these materials is the Indium Tin Oxide (ITO) electrode used in liquid crystal displays (LCDs) such as passive matrix LCD displays. An example of the use of ITO in LCDs is provided in U.S. Pat. No. 5,130,829. Brittle materials, such as ITO, fracture when exposed to strains above a certain limit and thus lose functionality. Once a crack has formed in the brittle material, it generally extends further until the crack splits the material into parts. If more than one crack forms in the layer, this propagation of cracks can result in ‘islands’ of material that, when the layer is used as an electrical conductor, are electrically ‘floating’. Due to its brittleness, when strained, ITO is likely to crack or delaminate, having the effect of reducing its conductivity. This greatly inhibits the performance of the display.

WO 96/39707 describes an electrode for use on flexible substrates, which is designed to retain more of its conductivity for greater amounts of strain. To achieve this, a coating of a second more flexible conductive material is applied such that it is in contact with the relatively brittle electrode material. Accordingly, when the brittle electrode is put under strain and therefore starts to crack, electrical continuity is maintained via the second, more flexible material.

The drawback of this approach is that the second material has a much greater resistivity than the brittle electrode material. The price for increased flexibility is an increase in resistance of the electrode and accordingly this approach is not applicable where good electrode conductivity is required, such as in electronic displays.

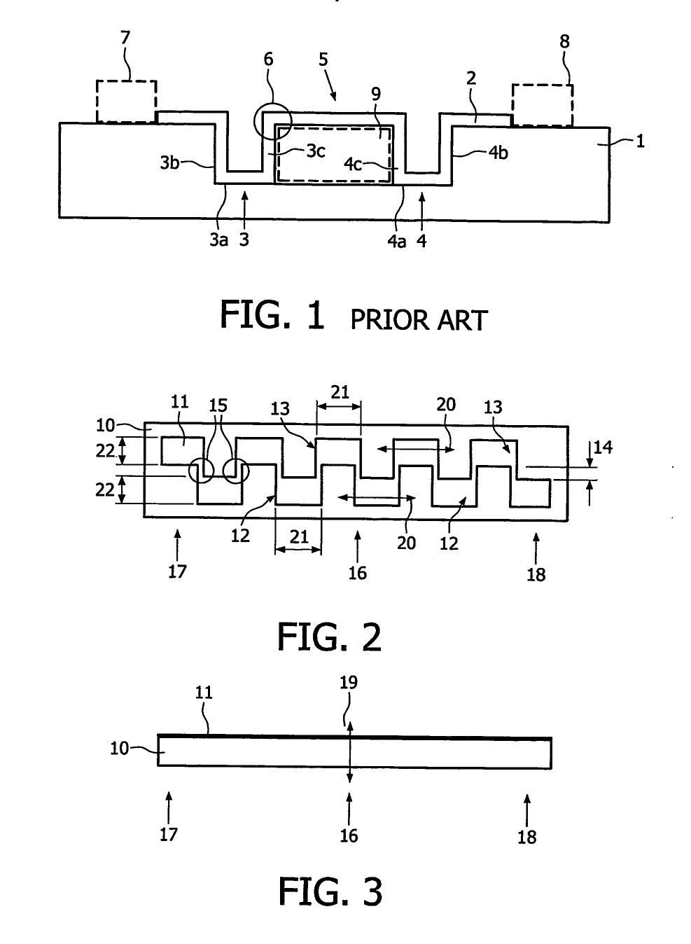

WO 02/45160 describes a flexible metal connector for providing a link between rigid substrate portions. A cross-sectional view of a flexible substrate 1 having a connector 2 with a similar structure to that described in WO 02/45160 is shown in FIG. 1. The connector 2 is formed by first and second troughs 3, 4 connected by a ridge 5. The base 3a, 4a and one side 3b, 4b of each of the first and second troughs are in contact with the substrate 1. However, the other side 3c, 4c of each of the first and second troughs and the ridge 5 connecting the troughs 3, 4 are not in contact with the substrate 1.

The structure of the connector 2 is such that it is able to flex in a concertina-like manner when strained and thus may withstand larger amounts of strain before fracture than conventional connectors. However, using this particular structure for brittle materials is inappropriate for several reasons. Firstly, the resulting structure is fragile. Secondly, as longitudinal strain is applied to the brittle conductor material, there would be a concentration of stress in the corners of the connector 2, for example the left-hand corner 6 of the ridge 5, causing the material to fracture.

Furthermore, a connector such as that of WO 02/45160, having raised bridging portions, would require several photolithographic steps for its manufacture, as are described in WO 02/45160. For example, in one process, the first step would be the deposition of a layer of photoresist onto the surface of the substrate 1. This would then be patterned to leave three blocks, one 7 marking the left-hand boundary of the connector 2, one 8 marking the right-hand boundary and the last 9 formed to shape the ridge 5 of the connector 2. The next step would be that of depositing a thin electroplating seed layer, for instance copper over chromium, to the substrate, covering the blocks of photoresist 7, 8, 9 and the exposed substrate. The connector 2 would then be electroplated over the seed layer. In a final stage, the photoresist blocks 7, 8, 9 are removed.

These steps required for the fabrication of the connector 2 of FIG. 1 add time and expense to the production process of flexible devices. Also, for certain applications, substrates having a raised topography, such as that which would be necessary for ITO layers formed using the approach of WO 02/45160, are undesirable. One example of this is LCDs, for which it is preferable to limit substrate thickness.

The present invention aims to address the above problems. According to a first aspect of the invention there is provided a device comprising first and second layers wherein the first layer is flexible and the second layer is substantially flat and meanders across the plane of the first layer so as to prevent fracture of the second layer when the first layer is deformed.

The shape of the second layer can enable it to be more flexible than conventional non-meandering layers, while maintaining a relatively thin structure overall. A flat second layer is also easier to fabricate than the prior art structures described above.

The second layer may be in contact with the first layer over substantially the whole of the length of the second layer.

The second layer can comprise a plurality of interconnected, portions.

Tests have shown that the edges of functional layers on flexible substrates under strain can be under less stress than other regions of the functional layers. Accordingly, a layer formed using interconnected portions rather than a single continuous region of material has more edge regions and can therefore have benefits of reducing the stress in the layer when under strain. This can make the layer less likely to fracture and increase the operational lifetime of the layer.

Cracks in functional layers under stress generally start as small cracks at the edges of the layer. The cracks then extend across the layer, generally requiring relatively little stress in the layer to do so. A layer comprising a plurality of interconnected portions can have the advantage of limiting the propagation of cracks across the layer. This can therefore enable the functional layer to maintain its operational performance for longer.

The portions can be arranged in aligned sets, the portions being connected to one another so as to provide a continuous path between first and second ends of the second layer. The aligned sets may be offset from one another.

The portions can be connected to one another by a connecting element which can be narrower than the portions being connected. This can minimise the risk of fracture further since the path of cracks from one portion to an adjoining portion can be limited in size. Narrower connecting portions can also enable the structure to better resist twisting motions during deformation.

The interconnected portions can comprise substantially quadrilateral portions or substantially hexagonal portions.

The interconnected portions can be arranged in an array of interconnected portions.

At least one of said interconnected portions can be connected to three or more other portions. This can have the advantage of introducing redundancy to the connections between the portions such that if one of the connections fractures, electrical continuity can be maintained via the remaining two connections.

Each of the portions may have a predetermined length, the portion length being selected to prevent fracture when the first layer is deformed to a predetermined radius of curvature. The portion length may be selected to be less than a predetermined length, the predetermined length being dependent on the average length between cracks for a continuous layer deformed to the predetermined radius of curvature.

Having the lengths of the portions determined in this way enables the portions to be fabricated such that they are of a length that is unlikely to crack or delaminate when the first layer is deformed to a predetermined radius of curvature.

According to a second aspect of the invention there is provided a method of fabricating a device comprising first and second layers wherein the first layer is flexible and the second layer is substantially flat and meanders across the plane of the first layer so as to prevent fracture of the second layer when the first layer is deformed, the second layer comprising a plurality of interconnected portions each having a portion length, the method including selecting the portion length to prevent fracture when the first layer is deformed to a predetermined radius of curvature.

The method may further comprise determining a spacing between fractures for a continuous layer of material, when deformed to a predetermined radius of curvature, and selecting the portion length to be a value that is dependent on the determined spacing. The method may comprise determining an average spacing between the fractures.

According to a third aspect of the invention there is provided a device comprising a layer on a flexible substrate, the layer comprising a plurality of conductive islands, each island being multiply connected to one or more other islands so as to form a conductive path across the substrate.

The islands may be substantially hexagonally shaped or of a substantially quadrilateral shape.

For a better understanding of the invention, embodiments thereof will now be described, purely by way of example, with reference to the accompanying drawings, in which:

FIG. 1 is a cross-sectional view of a prior art connector on a flexible substrate;

FIG. 2 is a plan view of a meandering layer on a flexible substrate according to the invention;

FIG. 3 is a cross-sectional view of a functional layer on a flexible substrate;

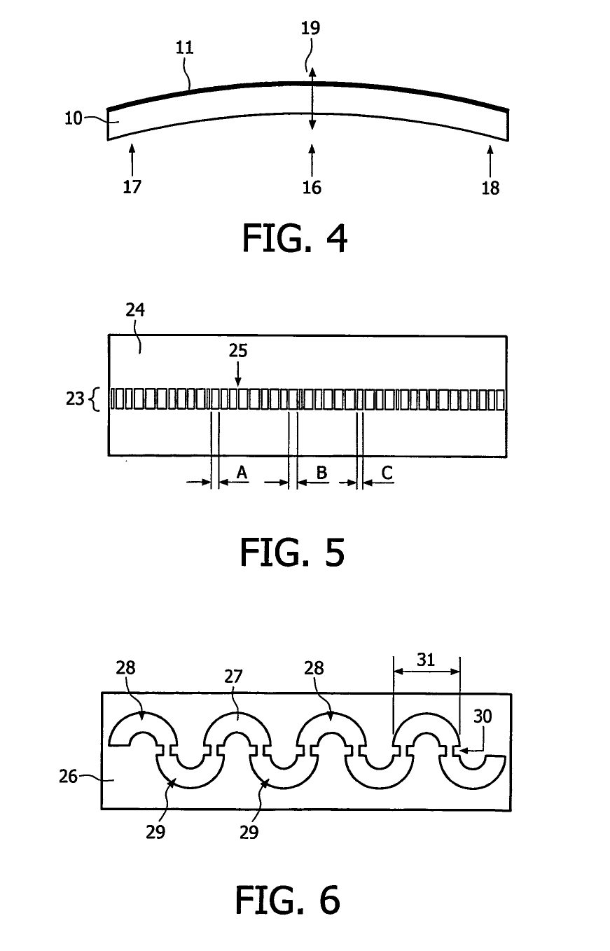

FIG. 4 is a cross-sectional view of a functional layer on a flexible substrate under strain;

FIG. 5 is a plan view of a conventional ITO layer on a flexible substrate that has undergone bending;

FIG. 6 is a plan view of a layer having undulating portions on a flexible substrate according to the invention;

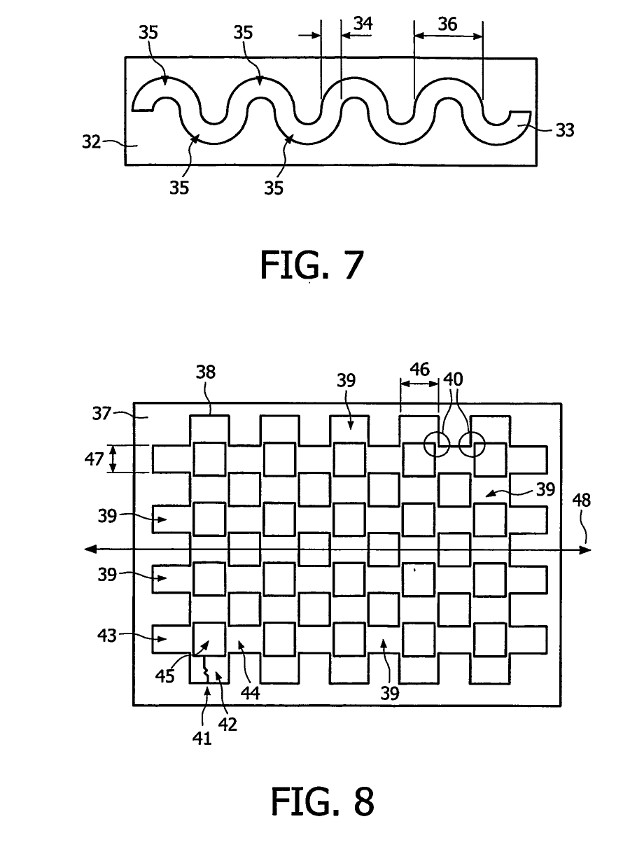

FIG. 7 is a plan view of an undulating layer on a flexible substrate according to the invention;

FIG. 8 is a plan view of a layer comprising an array of rectangular portions on a flexible substrate in accordance with the invention;

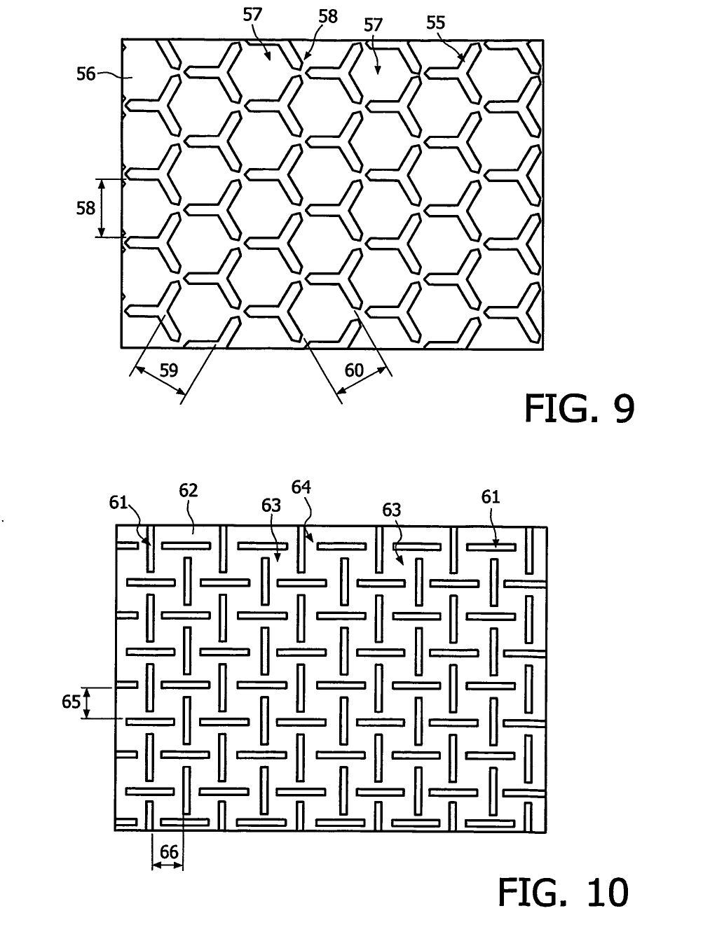

FIG. 9 is a plan view of a layer comprising an array of interconnected hexagonal portions in accordance with the invention;

FIG. 10 is a plan view of a layer comprising an array of interconnected square portions in accordance with the invention;

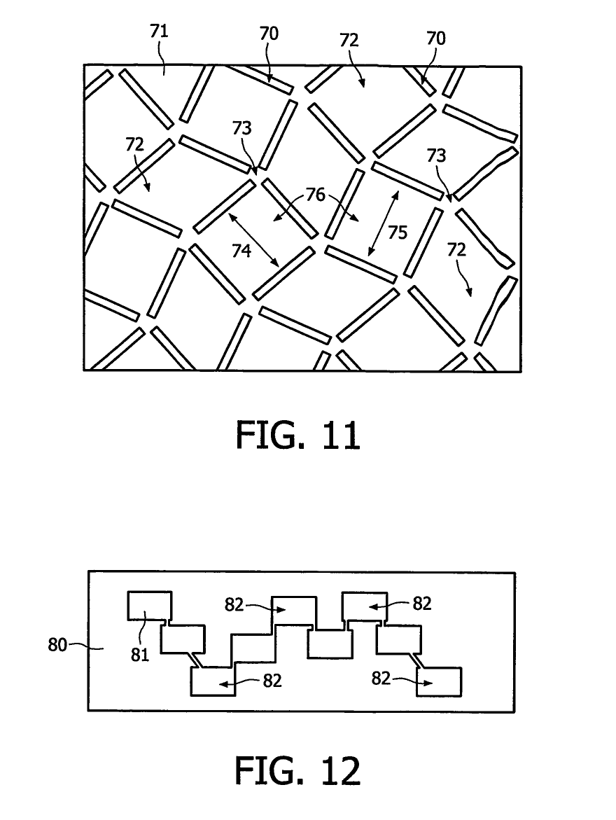

FIG. 11 is a plan view of a layer comprising an array of interconnected quadrilateral portions in accordance with the invention;

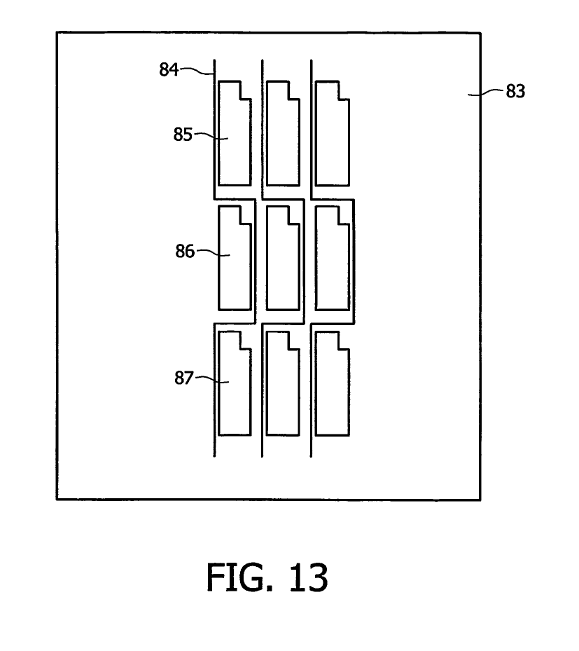

FIG. 12 is a plan view of a layer comprising randomly distributed portions on a flexible substrate according to a further aspect of the invention; and

FIG. 13 is a plan view of a line geometry for an electrode for an active matrix liquid crystal display device in accordance with the invention.

Referring to FIG. 2, a portion of the structure of a flexible liquid crystal display (LCD) is illustrated in plan view. This comprises a first layer 10 and a second layer 11. In this example, the second layer 11 is a layer of Indium Tin Oxide (ITO), which is a brittle material used for conductor lines in LCDs. Other brittle layers having other functions could form the second layer. The ITO layer 11 forms a conductor line that travels in what is referred to here as a longitudinal direction across the first layer 10 and is supported along its length by the first layer 10, which, in this example, is a polycarbonate substrate. The ITO layer 11 comprises first and second sets of rectangular portions 12, 13 aligned in the longitudinal direction, one set being offset from the other in the longitudinal direction. The sets are also spaced apart from each other by a predetermined distance 14. Each end of each of the rectangular portions of the first set 12 is connected to an end of a rectangular portion of the second set 13 by a relatively narrow connecting portion 15, such that the ITO layer 11 has electrical continuity along its length. The ITO layer 11 thus has a meandering shape. The rectangular portions of the first and second sets have lengths 21 of 300 μm and widths 22 of 100 μm. This may of course vary depending on the application.

FIG. 3 illustrates a cross-sectional view of the portion of the LCD depicted in FIG. 2. The substrate 10 is flexible and, in particular, the centre portion 16 may move up and down in relation to the end portions 17, 18, as depicted by the double-ended arrow 19. In this manner, the substrate 10 may be bent to have a certain radius of curvature r.

FIG. 4 is a cross-sectional view of the LCD portion of FIGS. 2 and 3 when under strain. When the substrate 10 is strained, stress is exerted on the substrate 10, the stress being at its greatest at the upper and lower surfaces of the substrate 10, the upper surface being that on which the ITO layer 11 is applied. Depending on the direction of movement of the centre portion 16 in relation to the ends 17, 18, either a compressive or tensile stress will be exerted on the upper surface of the substrate 10. This will cause a strain in the brittle ITO layer 11.

The meandering structure of the ITO layer 11 enables it to withstand higher strains before fracture than would otherwise be possible. This gives the layer “concertina-like” properties, such that the portions 12, 13 can move in relation to each other in the longitudinal direction as illustrated by the arrows 20 in FIG. 2, to reduce or increase the longitudinal length of the ITO layer 11 and thus enable it to absorb larger longitudinal strains. The terms “longitudinal strain” and “longitudinal length” used throughout this specification refer to strains and lengths across the substrates as shown in the Figures, for instance from the left-hand end 17 to the right-hand end 18 of the substrate 10 illustrated in FIG. 2.

The functional layer 11 may be any of numerous brittle functional coatings, such as a scratch-resistant coating, a solvent or gas resistant coating, or a conductive coating, for instance a polymeric conductor Poly-3,4-Ethylenedioxythiophene (PEDOT) or Transparent Conductive Oxide (TCO), an example being Indium Tin Oxide (ITO). These coatings generally have higher values of Young's Modulus to those of the materials used for the substrate 10. Accordingly, they are more likely to fracture when strains, at which the substrate 10 may be stable, are exerted on them.

The thickness of the functional layer 11 and of the flexible substrate 10 are dependent on the particular application and the materials used. In the case of an LCD having a flexible polycarbonate substrate with an ITO electrode layer, the thickness of the substrate is likely to be to the order of 0.1 to 1 mm, with an ITO layer thickness of 50 to 200 nm.

The functional layer 11 may, for example, be formed by vacuum deposition, for example spluttering or vapour deposition, followed by photolithographic patterning. Alternatively, a printing technique such as ink-jet printing, soft lithographic techniques such as microcontact printing, flexographic printing or screen printing may be used. The specific processes involved in these methods and other methods for applying the functional layer 11 would be apparent to the skilled person. The choice of method and processes involved in the chosen method will depend on the exact material required for the functional layer 11.

Due to the fact that the functional layer 11 has no raised topographical structure, unlike the connector 2 of FIG. 1, the steps involved in producing it are relatively simple in comparison to those necessary to produce more complicated structures having the same purpose. Also, the layer thickness is minimal, which is an advantage in the fabrication of devices where minimising overall substrate thickness is desirable. One such example is the fabrication of LCDs.

As is shown in FIG. 3, the resulting structure of layer 11 is supported along its length by the substrate 10. This property ensures that the layer 11 is robust.

The lengths 21 of the long sides of the rectangular portions 12, 13 of the functional layer 11 will influence the properties of the functional layer 11 when under strain. When crack formation in an ITO line on a flexible substrate undergoing tensile or bending tests is analysed, a statistical pattern emerges. For a certain radius of curvature of the flexible substrate, the ITO line may, for example, crack perpendicularly at roughly 300 μm intervals. However, each of the 300 μm sections thus formed will then be stable and will not exhibit further cracking until the substrate undergoes a further change to a smaller radius of curvature. Hence, for each radius of curvature to which the flexible substrate is bent, there is a length of ITO line that will be stable and therefore less likely to crack.

FIG. 5 is a plan view of a conventional ITO layer 23 on a flexible substrate 24 following deformation to a specific radius of curvature. As can be seen, cracks 25 have formed at intervals along the length of the ITO layer 23. The average distance between these cracks is dependent on the radius of curvature of the substrate 24. At a certain radius of curvature, r, of the substrate 24, the distance between the cracks (such as the distances A, B and C) may be measured. An average may then be taken of these values. A critical length, above which continuous portions of brittle layers on the flexible substrate when bent to radius r are likely to fracture, will be dependent on this average length. In practice, it has been found that the critical length for continuous portions may be up to three times the average length. Accordingly, the lengths 21 of the continuous portions 12, 13 of the ITO layer 11 are set to be no greater than the critical length, making the layer less likely to fracture when the substrate 10 is bent up to the radius of curvature r.

FIG. 6 is a plan view of a flexible substrate 26 having a functional layer 27, similar to that shown in FIG. 2. The layer 27 comprises first and second sets of essentially semicircular portions 28, 29 aligned in the longitudinal direction, one set being offset from the other in the longitudinal direction. The sets are also spaced apart from each other by a certain distance. Each end of each of the semicircular portions of the first set is connected to an end of a semicircular portion of the second set by a relatively narrow connecting portion 30, such that the ITO layer 27 has electrical continuity along its length. The ITO layer 27, in a similar manner to the layer 11 of FIG. 2, thus has a meandering shape.

Having curved portions 28, 29 rather than rectangular portions 12, 13 improves the properties of the functional layer 27 when strained. The functional layer 11 of FIG. 2 is more likely to have large stresses at the intersections of adjoining rectangular portions, causing it to fracture at these points. Stresses in the functional layer 27 of FIG. 6 will be more evenly distributed throughout the layer 27, due to its curved topographical shape. This topographical shape is therefore less likely to fracture.

The length 31 of the semicircular portions in one example is set to be no greater than the critical length previously described, making the undulated layer 27 less likely to fracture when the substrate 26 is bent up to the radius of curvature r.

Both the functional layer 11 of FIG. 2 and the functional layer 27 of FIG. 6 comprise narrow connecting portions 15, 30 respectively that run perpendicularly to the longitudinal direction of the ITO layers 11, 27. These are made narrow such that their widths are well below the critical length discussed above and hence they are very unlikely to fracture. These connecting portions 15, 30 may also twist as their ends are forced to rotate in different directions, due to the strains exerted on the functional layers 11, 27. The fact that they are narrow also reduces the likelihood that they will fracture as a result of such twisting. In alternative embodiments wider connection portions may be used. For example, FIG. 7 illustrates an embodiment in which a substrate 32 has a functional layer 33, wherein the connecting portions are effectively of the same width 34 as the curved portions 35. The curved portions 35 may have a length 36 that is set to be no greater than the critical length previously described.

Also, in further embodiments, the joints between connecting portions 15, 30 and rectangular portions 12, 13 or semicircular portions 28, 29 have rounded corners to more evenly distribute forces at the corners of these joints. The connecting portions 15, 30 are also not limited to being disposed perpendicularly to the longitudinal direction, but may be at an angle such as 45 degrees to the longitudinal direction.

The methods for applying the functional layers 27, 33 having undulating shapes to the substrates 26, 32 and the thickness of the resulting layers 27, 33, are similar to those discussed previously.

From reading the present disclosure, other variations and modifications will be apparent to persons skilled in the art. Such variations and modifications may involve equivalent and other features which are already known in the design, manufacture and use of flexible electronic devices and which may be used instead of or in addition to features already described herein.

In particular, the invention is not limited to use in electrodes in LCD displays, but may also be applied to other layers in a pixel stack, such as gate dielectrics and passivation layers and some electrode metallic lines. The invention is also not limited to use in an LCD display, nor to a polycarbonate substrate. It is also applicable to any flexible substrate having a functional coating. It is also applicable to other types of display, such as foil displays, e-ink displays, for instance e-ink displays including an electronic ink layer consisting of electrophoretic microcapsules coated onto a polyester/indium tin oxide sheet, poly-LED displays, O-LED displays and other electroluminescent displays, as well as touch screens and photovoltaic cells.

Also, the shape of the portions 12, 13, 28, 29 that form the layers 11, 27, in accordance with the invention, may differ from the rectangular and semicircular shapes illustrated in the Figures.

The layers may comprise three or more aligned sets of such portions, each offset and/or spaced apart from others. For example, FIG. 8 illustrates in plan view one such embodiment of the invention in which a substrate 37 is coated with a functional layer 38 comprising an array of rectangular portions 39. In this example, the layer 38 is a layer of ITO forming the counter or common electrode of an active matrix (AM) LCD display, and the substrate 37 is a plastic foil substrate. Each rectangular portion 39 is connected to surrounding portions via up to four connecting portions 40. Having more than two connecting portions 40 to surrounding or adjacent rectangular portions 39 introduces redundancy such that if one connecting portion 40 is fractured, electrical continuity can be continued across the layer 38 by the remaining connecting portions 40.

Forming the layer using portions 39 has the advantage of limiting the propagation of cracks in the layer. For instance, a crack 41 that has formed in a lower, left-hand portion 42 of the layer as depicted in FIG. 8 is less likely to propagate to surrounding portions 43, 44 due to the gap 45 in the ITO layer 38. A further advantage of using portions is that the stress in a layer such as the ITO layer 38 depicted is reduced at the edges of the layer. Having multiple portions 39 therefore reduces the overall stress in the layer 38.

Degradations to image quality of the LCD display caused by aperture loss and Moiré effects, can be avoided by making the size of the portions 39 much smaller than the pixel size of the LCD display, which, in this example, is approximately 300 um in length, and by using an arrangement of portions that has a different symmetry to the backplane of the AMLCD. In this example, both the length 46 and width 47 of the rectangular portions 39 can be set to be no greater than the critical length previously described. Accordingly, this layer 39 may be less likely to fracture when strains are applied to it in either the longitudinal direction, illustrated by the arrow 48 in FIG. 8 or in a direction perpendicular to the longitudinal direction.

FIG. 9 is a plan view of a further embodiment of the invention in which a substrate 55 is coated with a functional layer 56 that comprises a plurality of aligned sets of hexagonal portions 57 formed in an array. Each hexagonal portion 57 is connected to other portions 57 via up to three connecting portions 58. In a similar manner to previously described functional layer formations, the portions 57 of the layer 56 in the example of FIG. 9 meander across the substrate 55.

The layer 56 comprising hexagonal interconnected portions 57 has the advantages previously discussed associated with the use of portions rather than a continuous layer, and of redundancy by having more than two connecting portions 58 between adjacent hexagonal portions 57.

In this example, each or any of the three distances 58, 59, 60 between the parallel sides of the hexagons 57 may be set to be no greater than the critical length previously described. Accordingly, this layer 56 can be less likely to fracture when strains are applied to it in substantially any direction.

FIG. 10 is a plan view of a further embodiment of the invention in which a substrate 61 is coated with a functional layer 62 that comprises a plurality of sets of square portions 63 formed in an array. Each square portion 63 is connected to other portions 63 via up to four connecting portions 64. In a similar manner to previously described functional layer formations, the layer 62 in the example of FIG. 10 meanders across the substrate 61.

The layer 62 comprising square interconnected portions 63 has the advantages previously discussed associated with the use of portions rather than a continuous layer, and of redundancy by having more than two connecting portions 64 between adjacent square portions 63.

In this example, both the length 65 and width 66 of the square portions 63 can be set to be no greater than the critical length previously described. Accordingly, this layer 62 can be less likely to fracture when strains are applied to it.

FIG. 11 is a plan view of a further embodiment of the invention in which a substrate 70 is coated with a functional layer 71 that comprises a plurality of aligned sets of quadrilateral portions 72 formed in an array. In one example, some of these quadrilateral portions may be square and some may be diamond shaped. The arrangement does not form a symmetrical array as with previous examples, thus improving the mechanical properties of the layer 71 and reducing the likelihood of systematic fracture of the layer 71 when strained in various directions. Each quadrilateral portion 72 is connected to other portions 72 via up to four connecting portions 73. In a similar manner to previously described functional layer formations, the layer 71 in the example of FIG. 11 meanders across the substrate 70.

The layer 71 comprising quadrilateral interconnected portions 72 has the advantages previously discussed associated with the use of portions rather than a continuous layer, and of redundancy by having more than two connecting portions 73 between adjacent quadrilateral portions 72.

In this example, the dimensions of the quadrilateral portions 72, such as the length 74 and width 75 of the square portions 76 can be set to be no greater than the critical length previously described. Accordingly, this layer 71 can be less likely to fracture when strains are applied to it.

In further embodiments, portions may be randomly distributed such that the second layer is non-symmetrical, which may assist in the avoidance of the propagation of systematic fracture within the layer. FIG. 12 illustrates a plan view of a substrate 80 having a functional layer 81 comprising randomly distributed interconnected portions 82.

The functional layers depicted in FIGS. 8 to 12 can be applied to substrates using similar methods to those previously discussed.

The portions may also be positioned on a substrate and have sizes that are determined in accordance with the position of LCD pixels on the substrate. An example of an electrode line geometry for an active-matrix display on a flexible substrate 83 is shown in FIG. 13. An electrode 84 passes to the left of a first pixel 85, to the right of a second pixel 86 and then to the left of a third pixel 87. The period of the meander of the electrode 84 is determined by the spacing between the pixels. In alternative embodiments, the electrode 84 passes to one side of two or more pixels, before switching to the other side of the pixels, so producing a period which is an integer multiple of the spacing between the pixels. An irregular electrode meander can also be used, for example, passing one pixel on a first side, three on the second side, then two on the first side and so on. Numerous other arrangements would be apparent to the skilled person.

Optionally, a relatively thin layer of a polymeric conductor such as Poly-3,4-Ethylenedioxythiophene (PEDOT), a conducting material having improved mechanical properties to ITO, although less transparency, can be applied on top of any of the functional layers previously discussed to improve the durability of the layers. Alternatively, the functional layers themselves can be of a polymeric conductor such as PEDOT.

Although claims have been formulated in this application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention.

1. A device comprising first (10, 26, 32, 37, 55, 61, 70, 80) and second (11, 27, 33, 38, 56, 62, 71, 81) layers wherein:
the first layer is flexible; and
the second layer is substantially flat and meanders across the plane of the first layer so as to prevent fracture of the second layer when the first layer is deformed.

2. A device according to claim 1, wherein the second layer is in contact with the first layer over substantially the whole of the length of the second layer.

3. A device according to claim 1, wherein the second layer comprises a plurality of interconnected portions (12, 13, 28, 29, 35, 39, 57, 63, 72, 82).

4. A device according to claim 3, wherein the portions are arranged in aligned sets, the portions being connected to one another so as to provide a continuous path between first and second ends of the second layer.

5. A device according to claim 4, wherein the aligned sets are offset from one another.

6. A device according to claim 4, wherein the portions are connected to one another by a connecting element (15, 30, 40, 58, 64) that is narrower than the portions being connected.

7. A device according to claim 6, wherein the portions are aligned in a longitudinal direction and the connecting element (15, 30, 40, 58, 64) is disposed to be substantially perpendicular to said direction.

8. A device according to claim 3, wherein the interconnected portions (12, 13, 39, 82), comprise rectangular portions.

9. A device according to claim 4, wherein the portions (12, 13, 28, 29, 35, 39, 63, 72) are connected to one another at their respective ends.

10. A device according to claim 4, containing two aligned sets of interconnected portions (12, 13, 28, 29, 35).

11. A device according to claim 3, wherein the interconnected portions (28, 29, 35) comprise semi-circular portions.

12. A device according to claim 3, wherein the interconnected portions (12, 13, 39, 63, 72) comprise substantially quadrilateral portions.

13. A device according to claim 3, wherein the interconnected portions (57) comprise substantially hexagonal portions.

14. A device according to claim 3, wherein the interconnected portions (39, 57, 63, 72) are arranged in an array of interconnected portions.

15. A device according to claim 12, wherein at least one of said interconnected portions is connected to three or more other portions.

16. A device according to claim 3, wherein the second layer (81) comprises a random arrangement of portions (82) connected to one another so as to provide a continuous path between first and second ends of the second layer.

17. A device according to claim 3, wherein each of the portions has a length, the portion length being selected to prevent fracture when the first layer is deformed to a predetermined radius of curvature.

18. A device according to claim 17, wherein the portion length is selected to be less than a predetermined length, the predetermined length being dependent on the average length between cracks (25) for a continuous layer deformed to the predetermined radius of curvature.

19. A device according to claim 1, wherein the first layer is a substrate.

20. A device according to claim 19, wherein the substrate comprises polycarbonate.

21. A device according to claim 1, wherein the second layer is a coating on the first layer.

22. A device according to claim 21, wherein the second layer comprises a transparent conductor.

23. A device according to claim 21, wherein the second layer comprises a conductive oxide.

24. A device according to claim 23, wherein the conductive oxide comprises indium tin oxide.

25. A device according to claim 3, wherein the portions are interconnected to provide a continuous path for an electric current.

26. A device according to claim 1, comprising a third layer covering a portion of said the second layer.

27. A device according to claim 26, wherein said third layer is Poly-3,4-Ethylenedioxythiophene.

28. A device according to claim 3, comprising a display.

29. A device according to claim 28, comprising an electroluminescent display.

30. A device according to claim 28, comprising a foil display.

31. A device according to claim 28, comprising a liquid crystal display device.

32. A device according to claim 31, wherein each of the portions has a length, the portion length being dependent on the spacing and size of pixels in the liquid crystal display device.

33. A device according to claim 31, wherein the liquid crystal display device comprises an active matrix device.

34. A device according to claim 31, wherein the liquid crystal display device comprises a passive matrix device.

35. A device according to claim 33, wherein the active matrix liquid crystal display device comprises a plurality of spaced apart pixels (85, 86, 87) and the second layer comprises an electrode (84) which is arranged to meander periodically between the pixels, the period of the meander being dependent on the pixel spacing.

36. A device according to claim 35, wherein the period of the meander is an integer multiple of the pixel spacing.

37. A device according to claim 1, wherein the second layer comprises a brittle material.

38. A method of fabricating a device comprising first (10, 26, 32, 37, 55, 61, 70, 80) and second (11, 27, 33, 38, 56, 62, 71, 81) layers wherein the first layer is flexible and the second layer is substantially flat and meanders across the plane of the first layer so as to prevent fracture of the second layer when the first layer is deformed, the second layer comprising a plurality of interconnected portions (12, 13, 28, 29, 35, 39, 57, 63, 72, 82) each having a portion length, the method including selecting the portion length to prevent fracture when the first layer is deformed to a predetermined radius of curvature.

39. A method according to claim 38, further comprising determining a spacing between fractures (25) for a continuous layer (24) of material when deformed to a predetermined radius of curvature, and selecting the portion length to be a value that is dependent on the determined spacing.

40. A method according to claim 39, comprising determining an average spacing between the fractures (25).

41. A device comprising a layer (38, 56, 62, 71) on a flexible substrate, the layer comprising a plurality of conductive islands (39, 57, 63), each island being multiply connected to one or more other islands so as to form a conductive path across the substrate.

42. A device according to claim 41, wherein the islands are substantially hexagonally shaped.

43. A device according to claim 41, wherein the islands are of a substantially quadrilateral shape.

44. A device according to claim 41, wherein the layer comprises a transparent conductor.

45. A device according to claim 41, wherein the layer comprises a polymeric conductor.

46. A device according to claim 41, comprising a further layer coated onto the layer.

47. A device according to claim 46, wherein the further layer comprises a polymeric conductor.
